(19) United States
(12) Patent Application Publication
(10) Pub. No.: US 2002/0116720 A1
(43) Pub. Date: Aug. 22, 2002

(54) Multi-band coax extender for in-building digital communication systems

(75) Inventors: John B. Terry, Cumming, GA (US); Harold W. Jackson, Norcross, GA (US); Dorothy Terry, (US)

Correspondence Address: DANIELS & DANIELS, P.A., SUITE 200, GENERATION PLAZA, 1822 N.C. HIGHWAY 54, EAST, DURHAM, NC, 27713, US

(73) Assignee: coaXmedia, Inc., Cumming, GA

(21) Appl. No.: 10/071,007

(22) Filed: Feb. 7, 2002

Related U.S. Application Data
(63) Continuation-in-part of application No. 09/482,836, filed on Jan. 13, 2000.
(63) Continuation-in-part of application No. 09/818,378, filed on Mar. 27, 2001.
(60) Provisional application No. 60/267,046, filed on Feb. 7, 2001.
(60) Provisional application No. 60/115,646, filed on Jan. 13, 1999.
(60) Provisional application No. 60/193,855, filed on Mar. 30, 2000.

(51) Int. Cl. H04N 7/173; H04L 12/28; H04L 12/56

(52) U.S. Cl. 725/118; 725/127; 370/408

(57) ABSTRACT

A method and system to expand digital transmission capacity in a “tree and branch” coax distribution system employing distributed TV signal amplifiers. Specifically, a number of separate bands are used in a main feeder cable that are frequency shifted and applied to a number of local coax distribution networks. In the preferred embodiment each of the local coax distribution networks use the same pair of upstream and downstream frequencies. Using identical pairs of upstream and downstream frequencies allows the use of a single standardized non-tuning end-user data interface (client modem), that can be connected to any of the local coax distribution networks. This abstract is provided as a tool for those searching for patents, and not as a limitation on the scope of the claims.

### CROSS-REFERENCE TO RELATED APPLICATIONS

This application claims priority to a provisional application filed Feb. 7, 2001 with U.S. Serial No. 60/267,046. This application provides a way to boost the signal carrying capacity of a system to provide High Speed Data Communication Over Local Coaxial Cable as described in co-pending application Ser. No. 09/482,836 based on Provisional Application No. 60/115,646 filed Jan. 13, 1999. This application claims priority to the '836 application and also claims priority to another application assigned to common assignee coaXmedia, Inc and its priority document. The title of the claimed application is Architecture and Method for Automated Distributed Gain Control for Internet Communications for MDUs and Hotels (application Ser. No. 09/818,378 based on Provisional Application No. 60/193,855). The '855 application has the filing date of Mar. 30, 2000.

For the convenience of the reader, applicant has added a number of topic headings to make the internal organization of this specification apparent and to facilitate location of certain discussions. These topic headings are merely convenient aids and not limitations on the text found within that particular topic.

In order to promote clarity in the description, common terminology for components is used. The use of a specific term for a component suitable for carrying out some purpose within the disclosed invention should be construed as including all technical equivalents which operate to achieve the same purpose, whether or not the internal operation of the named component and the alternative component use the same principles. The use of such specificity to provide clarity should not be misconstrued as limiting the scope of the disclosure to the named component unless the limitation is made explicit in the description or the claims that follow.

### BACKGROUND OF THE INVENTION

Technical Field

The present invention adds to the field of data communications. More particularly the invention is one of the ongoing improvements in the area of data communications addressing the use of tree and branch distribution systems for upstream and downstream data communication between a hub-server and a set of two or more client modems. Preferably, the client modems are adapted to allow a plug and play connection or other easy connection between a laptop and the tree and branch network. The tree and branch network is preferably connected to the Internet. Thus, the present invention can be used in a hotel or Multiple Dwelling Units (MDU's) or analogous buildings to allow plug and play access to the Internet over existing coax television networks. Note, the present invention is not limited to installations in a hotel or Multiple Dwelling Units (MDU's) or analogous buildings, these are examples of locations that can use the benefits of the present invention.

The '836 application describes a system that allows the connection of devices such as personal computers to special modems that connect to a legacy tree and branch coax network in a hotel, Multiple Dwelling Units (MDUs), or analogous building. The system described in the '836 application used two bands outside of the range used for cable TV. Thus, the system would have one frequency range for a downstream data channel and one frequency range for an upstream data channel. As this is a tree and branch network, all communications heading downstream must identify which modem device (or devices) are being addressed since all modem devices will receive the communication. Conversely, the communication from the many individual modem devices to the upstream end of the network must be controlled so that only one modem device is sending an upstream communication at any one time in order to avoid distortions to the upstream data resulting from more than one client modem transmitting on the same frequency at the same time (“bus contention”). The method of control used in the referenced applications is based on a polling and response model.

The present invention improves prior work by assignee coaXmedia, Inc. by providing a way to increase the capacity of the main feeder cables to carry communications to and from client modems.

In the preferred embodiment, the client modems are all mass-produced to operate at the same pair of upstream and downstream frequency bands.

The situation addressed by both the referenced applications and the current invention is shown generally in FIG. 1.

Environment

The previously described solution can be summarized by FIG. 1. In FIG. 1, the bandwidth between 50 MHz and 860 MHz (108) is allocated for downstream transmission of television signals. The band of 5 MHz to 42 MHz (104) is used for the existing services that use upstream traffic such as pay-per-view. Much of the frequency band between 860 MHz and 900 MHz (112) is used for other applications such as cellular telephones. Due to the relatively high field-strength radiation of portable cellular handsets, it is prudent to avoid using frequencies close to those used for cellular telephones.

The legacy coax distribution networks have splitters and couplers that operate satisfactorily up to approximately 1 GHz (1000 MHz). Thus, the '836 application and the '378 application suggested having a downstream frequency for data and an upstream frequency for data, both in the band between 900 MHz and 1000 MHz. In FIG. 1, the upstream frequency is shown at 915 MHz (116) and the downstream frequency is shown at 980 MHz (120). A single pair of upstream and downstream frequencies was thought sufficient to serve the statistical two-way Internet access needs of fifty to one-hundred users or client modems.

The '378 application taught that additional downstream spectra can be allocated in bands between 1 GHz and about 1.6 GHz provided that existing components are replaced with components that work adequately in this frequency band. This solution would require a means for the client modem to recognize a request to switch from the normal downstream channel of 980 MHz to the high frequency channel. Thus, in addition of the cost to upgrade the components of the legacy coax network, there would be a need to provide more expensive client modems that can operate on multiple downstream frequencies.

Problem Being Addressed

As illustrated in FIG. 2, larger Multi-Dwelling Unit (MDU) in-building coax cable TV distribution systems commonly have many more than fifty coax receptacles. These larger distribution systems normally have a mix of local services 604 in addition to the TV channels. In a hotel the local services might include a digital video server, check-out information and information about the hotel restaurants.

The local services 604 and cable television channels 608 would be combined at element 612 and amplified by central location amplifier 620 before the feeder cable 624 (sometimes called a coax riser).

An even larger system might include one or more central location splitters 630 to feed additional pairs of an amplifier 634 and another long feeder cable 638. To avoid clutter in the drawing, the local distribution networks connected to long feeder cable 638 are not shown. These distribution systems require intermediate amplifiers 650 to boost the signal levels that have been attenuated by coax cable, splitter and directional tap losses, in order that sufficient signal levels be provided to television sets and/or other entertainment equipment. These intermediate amplifiers 650 are distributed within an MDU at some distance from the central feed point to the building which may provide services from CATV, TV broadcast antenna or via means such as fiber optics. These intermediate amplifiers 650 normally carry TV channel signals in one direction only, usually at frequencies in the range 50 MHz to 750 MHz. In some cases these amplifiers are equipped with a reverse direction amplifier that can carry signals in the frequency range 5 MHz to 42 MHz. The reverse channel is sometimes used to carry command signals for requesting pay-per-view (PPV) television services or, with increasing frequency, the upstream channel of a cable modem used for Internet access.

When the TV coax distribution system is utilized to carry data outside of the CATV frequency band, there is a need to provide bypass amplifiers for each signal direction, connected to the coax cables via frequency selective diplexers. Thus, when implementing a system to carry data on an existing cable television network, there is a need for circuitry such as shown in FIG. 3 to boost the data signals.

FIG. 3 operates without interference to the operation of existing CATV line extender amplifier 650. The amplifier 650 is isolated by a pair of low-pass filters 654 in diplexers 660. A high frequency bypass around the existing amplifier 650 is provided by a pair of high-pass filters 658. The bypass is split into a downstream channel and an upstream channel by splitters 664. The downstream channel and the upstream channel are isolated from one another by shielding 668.

For a system using 980 MHz as the downstream frequency and 915 MHz as the upstream frequency, the downstream channel is comprised of a 980 MHz bandpass filter 672, a variable attenuator 676, an amplifier 680, and a 915 MHz band-stop filter 684. The upstream channel is comprised of a 915 MHz bandpass filter 688, a variable attenuator 676, an amplifier 692, and a 980 MHz band-stop filter 696.

When too many users share the data distribution system, there may be insufficient capacity. Insufficient capacity can lead to service degradation in the form of lost or delayed data packets. The number of users that is “too many” is a function of the type of data needs for the individual users. How many users are “too many” users? It depends on whether the users are likely to be connected at the same time, the need to receive or transfer large amounts of data and the sensitivity of the applications to delays in receiving data packets. As the amount of data communicated to a single connected user increases with the evolution towards multimedia, video conferencing, and other data intensive applications, the number of users that can be supported by the data networks will drop. Low latency applications such as video conferencing or voice over IP (Internet Protocol) exacerbate the problem.

While it may seem attractive to simply use additional frequencies for the upstream and or the downstream channel, this is not an attractive solution.

There are several advantages to having a set of client modems that are tuned to receive a single downstream frequency and to transmit on a single upstream frequency. For example, manufacturing and set up costs are reduced if there is not the need to provide modems that can be tuned to operate on a range of receive or transmit frequencies.

Even if a designer was willing to forego the advantages of using the same pair of transmit and receive frequencies for an entire set of client modems, there are practical limits to the number of frequency bands available above 900 MHz. One problem is that approximately 1 GHz is an effective frequency ceiling. This limitation comes from the reality that the splitters, directional taps, connectors and sometimes the coax cable itself in the distal portions of the coax distribution tree and branch network frequently perform poorly at frequencies much beyond 1 GHz.

Using several frequency channels in the spectrum above 900 MHz and below 1 GHz has its own problems. One problem is that adding additional channels will result in increased total signal power. This additional signal power will then increase the risk of signal overload in the active elements of the network. The overload can adversely impact the delivery of TV services. An additional problem is that adding more channels will increase the complexity of filters required to separate the individual channels.

Fortunately, the main (feeder) coax distribution cables (624, 638) connecting TV signals between the feed point to the building and the distributed “booster” amplifiers 650 are usually able to carry frequencies well above 1 GHz, as these feeder cables do not usually include directional taps or splitters. Even if there are a few taps or splitters before the booster amplifiers it will be easy to replace or upgrade the components. It will be easy because even if there are taps or splitters before the booster amplifiers, there will only be a few and they are easily accessible. This is in sharp contrast to the situation after the booster amplifiers where there are many taps and most are difficult to access.

### BRIEF SUMMARY OF DISCLOSURE

The present invention solves the prior art limitations by utilizing a two-stage system. In the preferred embodiment, the feeder cable stage takes advantage of the capacity of the feeder cable to carry multiple bands of data in the frequency spectrum above 1 GHz. The local stage converts these bands of data into corresponding bands in the frequency range 900 MHz to 1 GHz, at the TV “booster” amplifier locations, and amplifies these downstream communications for onward transmission to end users connected in groups to individual local tree and branch networks in the TV coax distribution system. Likewise, at least some of the upstream communications are shifted to a frequency above 1 GHz for upstream transmission on the feeder cable. The solution of the present invention offers significantly higher data capacity in a system in which all data interface “modems” can be identical and without complex tuning functions. Thus, the modems for use at the end user termination points of the tree and branch network can be mass produced and preset for given upstream and downstream channels as the many upstream and downstream bands are converted into standard upstream and downstream frequency channels for the local stage of the distribution. The modems can be used interchangeably on several different local tree and branch networks.

Optionally, one set of upstream and downstream communications can travel on the feeder cable at the frequencies used by the client modems so that no frequency shifting is required for this fraction of the communications. While using the same frequencies for all client modems may be desirable for administrative or economic reasons, the present invention is not limited to networks where all client modems operate solely on one pair of upstream and downstream frequencies. Alternative frequencies bands, other than above 1 GHz, are suggested in the discussion of alternative embodiments.

### BRIEF DESCRIPTION OF THE DRAWINGS

FIG. 1 shows the frequency bands used in the related applications to convey data upstream (116) and downstream (120) over a legacy tree and branch distribution network for cable television.

FIG. 2 illustrates the relationship between the feeder cables (624 and 638) with local coax distribution networks 762, 766, 768, and 770.

FIG. 3 illustrates the components in a line extender used to provide amplified signals for the data sent over the legacy tree and branch distribution networks.

FIG. 4 illustrates one embodiment of the present invention using three different downstream frequencies over the feeder cable 624 but only one upstream frequency over the feeder cable 624.

FIG. 5 illustrates another embodiment of the present invention using three different downstream frequencies over the feeder cable 624 and three different upstream frequencies over the feeder cable 624.

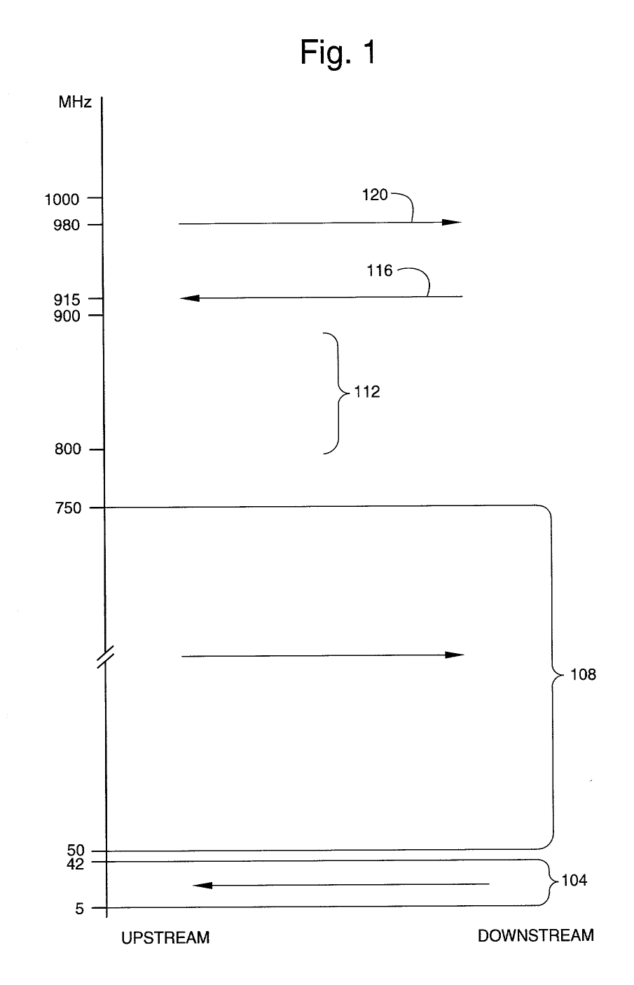

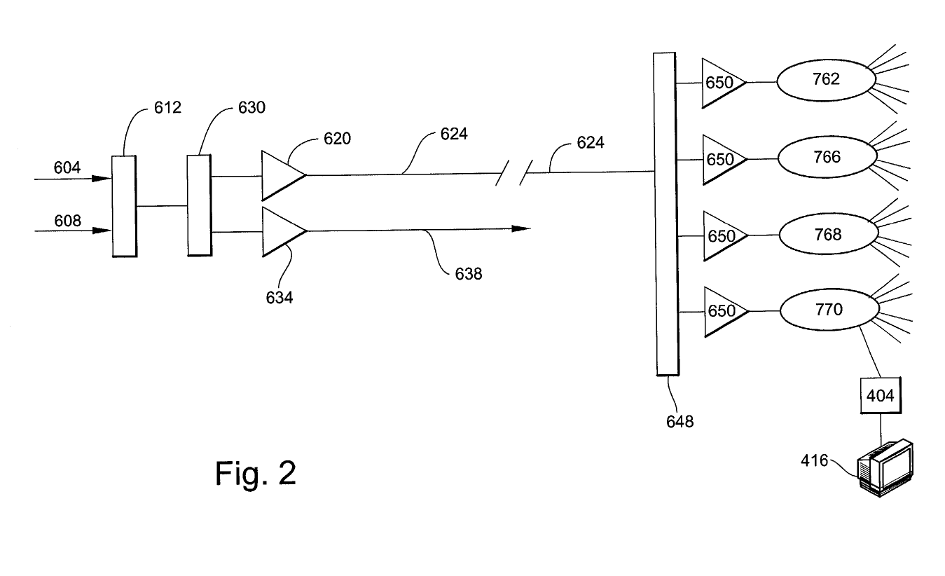

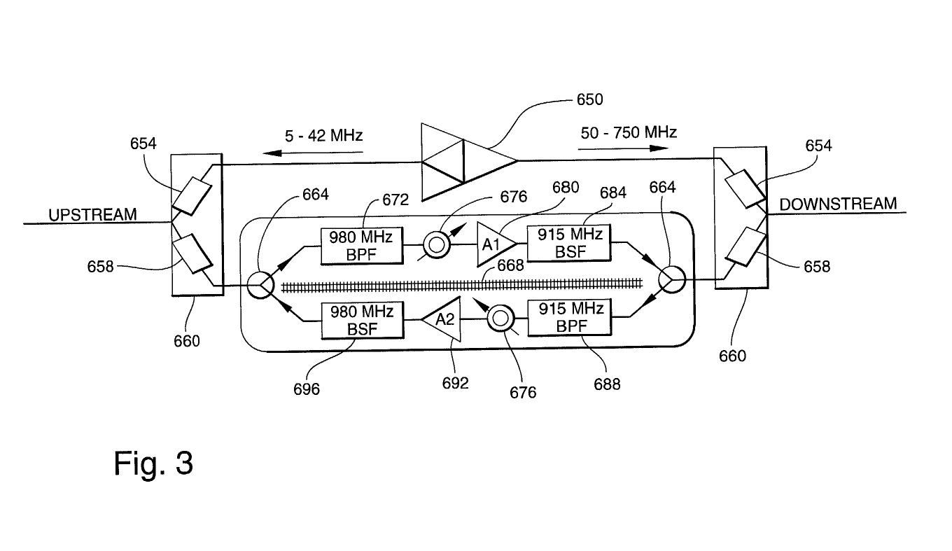

### DETAILED DESCRIPTION OF THE DISCLOSED EMBODIMENTS

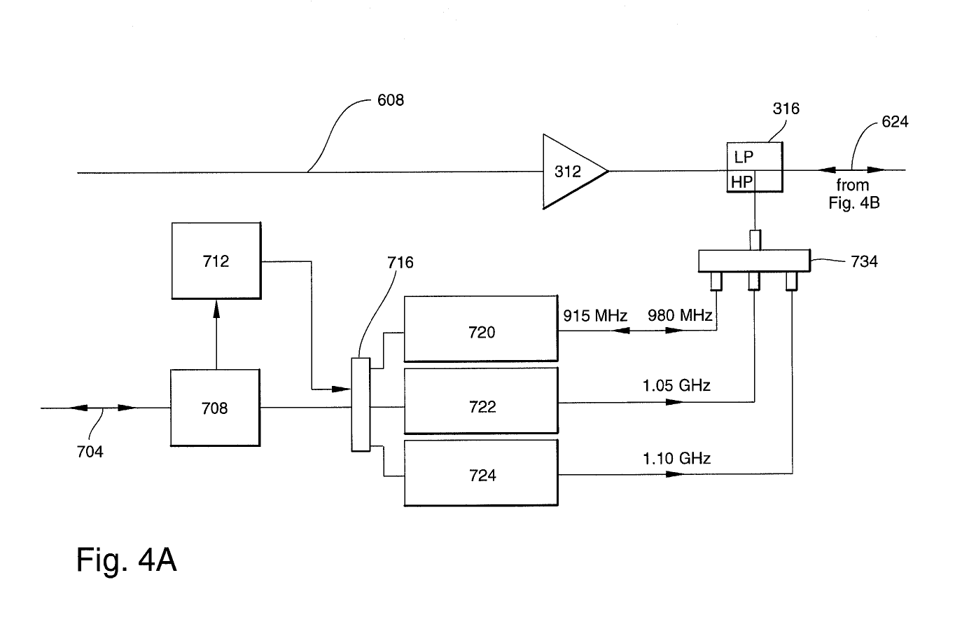

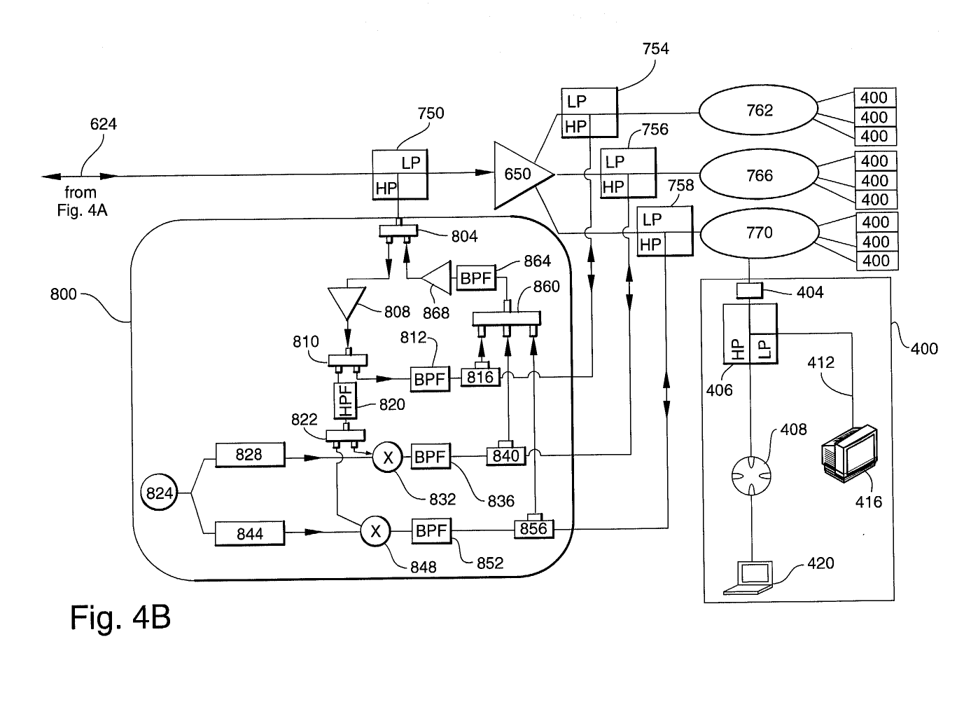

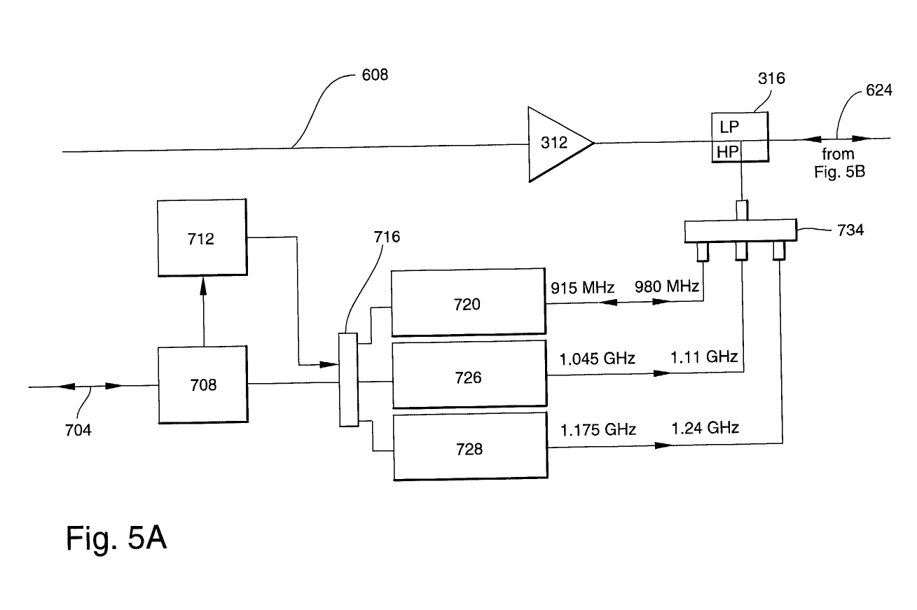

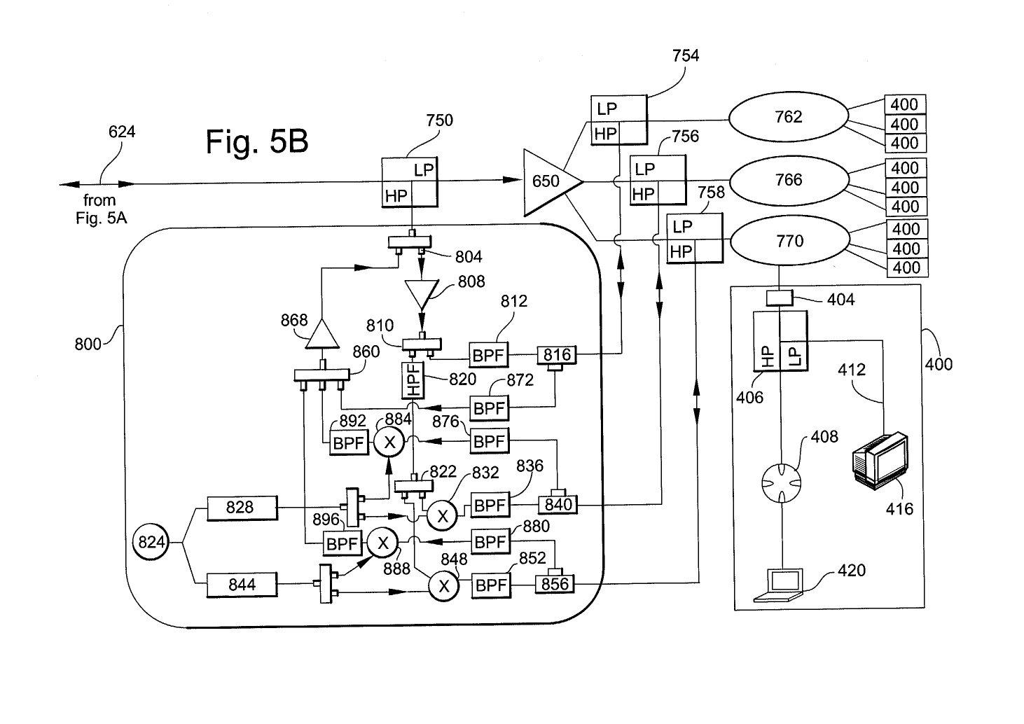

Overview of FIGS. 4 and 5

FIGS. 4 and 5 show two principal embodiments of the present invention. Both embodiments are shown on a combination of a Figure A that shows the equipment upstream of the feeder cable 624 and a Figure B that shows the equipment downstream of the feeder cable 624.

Both embodiments have one central system to feed one or more feeder cables (624 or 638) and ultimately a number of local networks. In the preferred embodiment, each local network would use standard client modems with pre-set frequencies for transmit and receive.

FIG. 4 differs from FIG. 5 in that FIG. 4 anticipates a situation where one upstream frequency is adequate for the entire set of client modems but the downstream data requirements exceed the bandwidth of a single downstream frequency. In both FIG. 4 and FIG. 5, the system uses several frequencies to carry downstream transmissions on the feeder cable before conversion to the standard downstream frequency for transmission on the parallel local networks. The embodiment of FIG. 4 will be suitable for many situations with much more information sent downstream to client modems than sent upstream from the client modems. Web browsing is one example of an application with this downstream/upstream imbalance. Much more downstream capacity is needed to convey the data necessary to construct a web page than is necessary to communicate upstream the simple request to display that web page. An additional load on downstream capacity is Value Added (VA) services, such as local digital video services, that require broadband capacity. The combination of downstream data from the Internet service provider with the bandwidth intensive Value Added services will frequently lead to a need for more downstream capacity than upstream capacity. In many situations, there will be too much downstream traffic for the existing feeder cables to carry it all on one downstream frequency in the 900 MHz to 1 GHz spectrum.

The system illustrated in FIG. 5 is like FIG. 4 in that the illustrated system has multiple downstream frequencies for the feeder cable. The embodiment shown in FIG. 5 differs from FIG. 4 in that it has more than one upstream frequency for the upstream travel through the feeder cable. FIG. 5 is adapted to work in situations where both the upstream and downstream traffic exceed the bandwidth for a single frequency on the feeder cable. Email or voice over IP are examples of applications that have a more even distribution between upstream and downstream data.

Details of FIG. 4

The cable television signals from coax 608 connected to the CATV service drop are amplified at amplifier 312 before reaching the low-frequency leg of diplexer 316.

The high-frequency leg of diplexer 316 receives data from Internet access, local Value Added services (if any), and from the digital video server 712 (if any). More specifically, the connection to the Internet 704 can be split from the CATV service drop cable 608, or come through another communication route such as fiber, cable modem, or wireless.

In FIG. 4A, the functions of a central hub are allocated across a set of components. The conversions from the Internet protocol to local network protocol occur in a central server 708. Typically, the conversions will be from Ethernet to PPPoE (PPP over Ethernet) in the downstream direction and the reverse for upstream transmission. Optionally, other local value added services can be administered in central server 708. Part of the local Value Added services can include a request for delivery of content from digital video server 712.

The downstream data including data from the digital video server 712 pass to a router 716 that distributes the data to a set of two or more central modems (720, 722, and 724). As this embodiment is set for a system with relatively small amounts of upstream traffic, only one central modem 720 is used to receive upstream traffic. In the example shown in FIG. 4A, the downstream traffic is carried to one set of client modems on feeder cable frequency 980 MHz. Downstream traffic to another set of client modems is carried on feeder cable frequency 1.05 GHz to take advantage of the capacity of the feeder cable to carry frequencies above one gigahertz. Downstream traffic to yet another set of client modems is carried on feeder cable frequency 1.10 GHz.

In the preferred embodiment, there would be an additional modem for each additional feeder cable frequency used for downstream traffic. As will be evident in the description of FIG. 4B, the use of the downstream frequency used by the client modems as one of the feeder cable frequencies reduces the amount of components used in FIG. 4B. Alternatively, the system could be set up to use downstream feeder cable frequencies above one gigahertz for all central modems and then convert all the downstream traffic to the downstream frequency used by the client modems.

The upstream traffic from all the client modems is transmitted on the single upstream feeder cable frequency of 915 MHz which is the same frequency used by the client modems. The coax cables from each of the three central modems are connected to combiner 734 which is connected to the high-frequency leg of diplexer 316.

FIG. 4B illustrates a multi-band coax extender for use with FIG. 4A. As an overview, the multi-band coax extender receives each of the three downstream bands and, using local frequency synthesizers and mixer elements, converts two of the received bands into two separate streams having bands identical to the third spectrum carried downstream on the main feeder. Each of these streams are then introduced, using spectral diplexers, into separate coax cable branches which may feed perhaps fifty or more client modems (such as the coaXmedia SandDollar™ client modem). In the upstream direction, using directional taps, same-spectrum signals from each of the separate coax cable branches are combined together, filtered to remove out-of-band noise, and amplified prior to insertion, as an upstream signal, onto the feeder cable 624 and back to the central modem 720 having an upstream receiver.

The system as described generally above is implemented in one embodiment with the following details shown in FIG. 4B. Starting at the distal end of feeder cable 624 as shown in FIG. 4B, the feeder cable 624 feeds diplexer 750. In one preferred embodiment, diplexer 750 is set with low pass from DC to 865 MHz and with high pass set to 905 MHz and above. The low-frequency leg of the diplexer 750 feeds the input to the television amplifier 650, which in turn feeds diplexers 754, 756, and 758. Each of the diplexers (754, 756, and 758) feeds a local coax distribution network 762, 766, or 770.

Depending on the anticipated loading, the distribution networks service approximately fifty end users. The distribution network terminates with equipment such as set forth in block 400. The details for one of the many blocks are shown on FIG. 4B. The actual layout of components within block 400 is not important for purposes of this invention and the sample given should not be interpreted as a limitation of the scope of the invention. For purposes of illustration, the components within block 400 are as follows:

Within cluster 400, a client modem 408 connects to the high-pass port on diplexer 406. Diplexer 406 is connected to the coax receptacle 404. Sample values for the downstream legs of the diplexer 406 are LP 5 MHz to 860 MHz and HP 900 MHz to 1 GHz. A conventional TV coax cable 412 connects a television 416 to the low-pass port on the diplexer 406. The client modem 408 is shown as a sand dollar in deference to the assignee's trademarked name for assignee's client modem.

The user may connect a downstream device 420 to the data cord of client modem 408. The user's downstream device 420 could be a personal computer (“PC”). While the downstream device 420 is likely to be either a desktop or laptop personal computer, it could be some other device capable of interfacing with an external source of digital data. One such example is the range of devices known as PDAs (“Personal Digital Assistants”). Thus, the present invention allows for communication between the downstream device 420 and the Internet through substantial use of existing infrastructure used to deliver cable TV signals to user's television 416. Each of the three diplexers (754, 756, and 758) receives downstream transmissions at 980 MHz and upstream transmissions at 915 MHz. While the aggregate downstream traffic for all three local coax distribution networks (762, 766, and 770) is too much to be carried on one frequency on the feeder cable 624, there is no problem having all the downstream traffic on the same frequency once it is divided among the three parallel local networks.

The components in block 800 handle the conversion from three feeder cable frequencies to three parallel local networks. The downstream path starts with diplexer 750 upstream of amplifier 650. The high-frequency leg of the diplexer 750 feeds splitter 804. The downstream path continues from the splitter 804 to amplifier 808. The portion of the downstream traffic at 980 MHz passes through a band pass filter 812 set at 980 MHz (passing plus or minus 20 MHz as do band pass filters 836 and 852). Since 980 MHz is the standard frequency used by the client modems 408, no conversion is necessary and the downstream traffic passes through the directional tap 816 to the high-frequency leg of diplexer 754 on route to local coax distribution network 762.

In parallel with the path for downstream traffic to local coax distribution network 762, there is a path for downstream traffic to local coax distribution network 766. Downstream traffic for network 766 at feeder cable frequency 1.05 GHz exits the amplifier 808 and passes through high-pass filter 820 set to pass frequencies above 1.02 GHz. The high-pass filter 820 is used to prevent residual lower-band spectrum, which could potentially pass directly through either of the mixers (832 or 848), from interfering with similar spectrum in the 980 MHz range created by the down-conversion from higher spectrum bands of the downstream traffic for local coax distribution networks 756 or 758.

Through use of oscillator 824, synthesizer 828, and mixer 832, the downstream traffic is shifted to 980 MHz and passes through band pass filter 836 and directional tap 840 to reach the high-frequency leg of diplexer 756. (Typical synthesizer output values would be 70 MHz or 2.03 GHz.) Diplexer 756 is connected to local distribution network 766.

In a similar way, the downstream traffic for local coax distribution network 770 travels on coax feeder 624 at 1.10 GHz. The downstream traffic passes through high-pass filter 820. Through use of oscillator 824, synthesizer 844 and mixer 848, the downstream transmission is shifted to 980 MHz and passes through band pass filter 852 and directional tap 856 to reach the high-frequency leg of diplexer 758. (Typical synthesizer output values would be 120 MHz or 2.08 GHz.) Diplexer 758 is connected to local distribution network 770.

As mentioned in connection with FIG. 4A, the downstream traffic to local coax distribution network 762 could have been carried on the feeder cable 624 on a frequency other than the standard downstream frequency (980 MHz) used by the client modems 408. This choice would require an additional synthesizer and mixer along with adjustments to the filter scheme.

The upstream traffic from the three local coax distribution networks is sent on standard frequency 915 MHz. The upstream path is from diplexers 754, 756, and 758 through directional taps 816, 840, and 856 to combiner 860.

The combined upstream traffic passes through band pass filter 864 set for 915 MHz (plus or minus 10 MHz). The upstream traffic is amplified at 868 and passes through splitter 804 to the high-frequency leg of diplexer 750 to feeder cable 624.

FIG. 4 illustrates a system with three modem pairs servicing three local distribution networks. In practice, any number of modem pairs may be combined in this matter, taking into consideration the required downstream capacity. Two small local distribution networks can share one pair of a modem and a feeder cable frequency. The present invention can be used in situations with two or more local coax distribution networks.

Details of FIG. 5

FIG. 5A illustrates a similar arrangement to that shown in FIG. 4A with the exception that each central modems (720, 726 and 728) includes an upstream receiver. Each receiver is tuned to a different coax feeder upstream frequency. The advantage of this arrangement is the multiplication of upstream capacity. The specific frequency bands shown are by way of example only as the principle may be applied independently of frequencies or spectrum used. As with the downstream frequencies, there is a slight advantage to using the standard transmit frequency for the client modems 408 as one of the coax feeder upstream frequencies. However, it is not required that one of the coax feeder upstream frequencies be the same as the standard transmit frequency for the client modems 408.

FIG. 5B illustrates a similar arrangement to that shown in FIG. 4B with exception that the same-spectrum upstream bands from two of the separate local coax distribution networks are frequency-shifted before being combined for transmission in an upstream direction on the main coax feeder 624. In this example, the downstream traffic at splitter 804 is carried on frequencies 980 MHz, 1.11 GHz, and 1.24 GHz. The upstream traffic at splitter 804 is carried on frequencies 915 MHz, 1.045 GHz, and 1.175 GHz.

More specifically, in the preferred embodiment, the upstream communications from local coax distribution network 762 passes through diplexer 754, directional tap 816, and band pass filter 872, to combiner 860 without modification of the upstream frequency of 915 MHz. (Typical values for band pass filters 872, 876, and 880 are 915+/−20 MHz).

The upstream traffic from local coax distribution network 766 is also at 915 MHz but after passing through diplexer 756, directional tap 840, and band pass filter 876, the upstream traffic is shifted to 1045 MHz by mixer 884 using synthesizer 838 output at 130 MHz. The shifted upstream traffic passes through band pass filter 892 set for 1045 MHz+/−20 MHz.

Similarly, the upstream traffic from local coax distribution network 770 also starts at 915 MHz. After passing through diplexer 758, directional tap 856, and band pass filter 880, the upstream traffic is shifted to 1075 MHz by mixer 888 using synthesizer 844 output at 260 MHz.

The shifted upstream traffic passes through band pass filter 896 set for 1075 MHz+/−20 MHz.

Alternative Embodiments

In the example shown in FIG. 5, a single heterodyne frequency source, provided by a synthesizer, is used to frequency shift both a downstream and an upstream signal. Thus, the amount of frequency shifting for both directions of transmission will be identical. Alternatively, separate heterodyne frequencies may be employed, thus enabling a more flexible frequency plan.

The system as set forth on FIGS. 5A and 5B uses 915 MHz for upstream communication and 980 MHz for downstream communication in the local coax distribution networks (762, 766, and 770). As shown in FIG. 5B, one of the pairs of frequencies transmitted on the feeder cable 624 is 915 MHz and 980 MHz, which is used without frequency shifting by one of the local coax distribution networks 762. This eliminates the need for an additional set of components to frequency shift these signals. While this is advantageous, it is not required and all of the bands may be frequency shifted without deviating from the scope of the present invention.

The band-pass filters included in FIG. 5B may be conveniently and economically created using printed circuit board stripline elements. Other forms of filter, such as ceramic or surface acoustic wave types may alternatively be employed.

The solution employed could have multiple local coax distribution networks using the same upstream or downstream frequency over the feeder cable 624 providing that the aggregate traffic on the feeder does not exceed its carrying capacity for a given frequency. Thus, several local coax distribution networks may use the same feeder cable frequencies as are used in the local coax distribution network. One or more of the other local coax distribution networks would shift one or both of the communication frequencies to add to the carrying capacity of the feeder cable 624.

The method described may be used in digital transmission systems using any form of modulation, or different forms of modulation on any portion of the coax distribution system.

The title and the disclosed embodiments of the present invention are given in the context of data communication using legacy cable television coax tree and branch networks. The frequencies chosen for the upstream and downstream communication reflect this environment. Note that one of skill in the art could select other frequencies or modulation schemes to implement this invention, especially in any tree and branch network that is not a coax network for use in distributing cable television signals, or in a tree and branch network that does not use coax.

When used in connection with data communication using legacy cable television coax tree and branch networks, the preferred embodiment uses frequencies on the feeder cable above the useful frequency range of the local distribution networks (typically frequencies above 1.0 GHz). Those of skill in the art could use the teachings of this invention to use additional carrier frequencies on the feeder cable to increase the bandwidth of the feeder cable through use of frequencies below 1.0 GHz. Generally, there are surmountable obstacles in using these other frequencies. The band of 5 to 42 MHz could be used, especially for an extra feeder cable downstream frequency, but this band is subject to a variety of uses that will change over time.

The frequency band set aside for television channels extends up to 860 MHz. Many systems do not use the frequency band from approximately 750 MHz to 860 MHz. This bandwidth could be used for additional feeder cable frequencies. A downside of using this band of frequencies is that cable television providers in some zones may already be using the 750 MHz to 860 MHz band, so this solution may not be universally applied. Another possible place to put additional feeder cable frequencies is in unused television channels within the band of frequencies used for television channels. Depending on the modulation and filter equipment used to convey the feeder cable frequencies, it may be necessary to find several contiguous unused television channels in order to carry one feeder cable frequency. A problem with using unused channels is that cable television providers rearrange the channels that are used to convey the television signals from time to time. A rearrangement by the cable television provider might cause a conflict with the plan to have extra feeder cable frequencies when unused television channels become active television channels, thus triggering a need to adjust the equipment to use a different frequency.

The frequency band of approximately 900 MHz to 1.0 GHz is yet another possible band to carry additional feeder cable frequencies. As noted above, there would be possible problems from aggregate signal power and the need for a more rigorous filter scheme in order to add additional feeder cable frequencies to this band as the preferred embodiment already uses 915 MHz and 980 MHz. While these factors point towards using the band above 1.0 GHz, the band between 900 MHz and 1.0 GHz could carry three or more feeder cable frequencies rather than two feeder cable frequencies.

Those skilled in the art will recognize that the methods and apparatus of the present invention have many applications and that the present invention is not limited to the specific examples given to promote understanding of the present invention. Moreover, the scope of the present invention covers the range of variations, modifications, and substitutes for the system components described herein, as would be known to those of skill in the art.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

What is claimed:

1. A tree and branch distribution network for conveying data communications and television signals; the network comprising:
A feeder cable for carrying television signals and data communications from an upstream end to a downstream end, the downstream end connected to a first local distribution network and to a second local distribution network; the feeder cable having the capacity to carry communications in a band of frequencies above the band of frequencies that can be used reliably in the first and second local distribution networks;
the first local distribution network isolated from the second local distribution network so that a downstream communication delivered to the first local distribution network on a first downstream frequency would not be readable on the first downstream frequency by a client modem connected to the second local distribution network;
Within each of the first and second local distribution networks, a set of client modems for receiving data at the distal ends of the two local distribution networks, the client modems adapted for communication to a device connected downstream of the client modem;
A connection to a source of data communications to be conveyed over the feeder cable to the set of client modems at the distal end of the local communication networks;
Data communications at a first feeder cable frequency carried downstream over the feeder cable, the data communications received from the source of data communications for transmission to one of the set of client modems at the distal end of the first local distribution network;
Data communications at a second feeder cable frequency carried downstream over the feeder cable, the data communications received from the source of data communications for transmission to one of the set of client modems at the distal end of the second local distribution network; the second feeder cable frequency suitable for the feeder cable and above the band of frequencies that can be used reliably in the local distribution networks; the second feeder cable frequency different from the first feeder cable frequency;
A downstream frequency shifter in data communication with the downstream end of the feeder cable and the second local distribution network to shift the data communications on the second feeder cable frequency to a downstream data frequency for the second local distribution network, the output of the downstream frequency shifter provided to the second local distribution network and conveyed to the set of client modems at the distal end of the second local communication network.

2. The tree and branch distribution network of claim 1 wherein the first feeder cable frequency equals a downstream data frequency for the first local distribution network.

3. The tree and branch network of claim 1 wherein the downstream frequency shifter comprises an oscillator, a synthesizer and a mixer.

4. The tree and branch network of claim 1 wherein the first local distribution network is isolated from the second local distribution network through use of directional taps positioned between the first and second local distribution networks and the feeder cable.

5. The tree and branch distribution network of claim 1 further comprising an upstream frequency shifter in data communication with the downstream end of the feeder cable and the second local distribution network to shift upstream communications from an upstream data frequency for the second local distribution network to a third feeder cable frequency; the third feeder cable frequency suitable for the feeder cable and above the band of frequencies that can be used reliably in the local distribution networks; the third feeder cable frequency different from the first feeder cable frequency and the second feeder cable frequency; the output from the upstream frequency shifter communicated to the feeder cable.

6. A multi-band extender for use in increasing the capacity of a tree and branch distribution network; the multi-band extender comprising:
a first splitter device connected to communicate with a feeder cable; the splitter device connected to the feeder cable through a connection that discriminates against frequencies in a first frequency band used by the feeder cable to carry television signals;
a downstream path exiting from the first splitter device and in data communication with a second splitter device;
an output of the second splitter device in data communication with a first filter to allow downstream travel of communications on a first frequency;
a first directional tap with a first port connected to a second port and to a third port, the second port isolated from the third port;
the first filter connected to the third port on the first directional tap;
the first port on the first directional tap connected to a high frequency port on a first diplexer; the first diplexer having a low frequency port in data communication with a source of television signals on the first frequency band below the first frequency;
a downstream leg of the first diplexer connected to a first local distribution network that is connected to at least one television and at least one client modem;
a second output of the second splitter device in data communication with a second filter to allow downstream travel of communications on a second frequency and to discriminate against communications on the first frequency;
the second filter connected to a downstream frequency shifter to shift the data communications on the second frequency to a second local distribution network downstream frequency;
a second directional tap with a first port connected to a second port and to a third port, the second port isolated from the third port;
an output of the downstream frequency shifter in data communication with the third port on the second directional tap;
the first port on the second directional tap connected to a high frequency port on a second diplexer; the second diplexer having a low frequency port in data communications with the source of television signals on the frequency band below the first frequency;
the downstream leg of the second diplexer connected to a second local distribution network that is connected to at least one television and at least one client modem.

7. The multi-band extender of claim 6 wherein: the second local distribution network contains at least one component rated for use in a frequency band range and the second frequency is outside the frequency band range.

8. The multi-band extender of claim 6 wherein the second frequency is above 1.0 GHz.

9. The multi-band extender of claim 6 wherein:
the second port on the first directional tap and the second port on the second directional tap are both in data communication with a combiner device;
an upstream output of the combiner device connected to the first splitter device whereby:
A) upstream communications from the first local distribution network may travel upstream from the first local distribution network, through the first directional tap exiting out the second port, before passing through the combiner device, before passing upstream through the first splitter device before reaching the feeder cable;
B) upstream communications from the second local distribution network may travel upstream from the second local distribution network through the second directional tap exiting the second port, before passing through the combiner device, before passing upstream through the first splitter device before reaching the feeder cable; and
C) the feeder cable carries:
television signals in the first frequency band;
downstream communications on the first frequency for use in the first local distribution network;
downstream communications on the second frequency (different from the first frequency) for use in the second local distribution network;
upstream communications from the first local distribution network; and
upstream communications from the second local distribution network.

10. The multi-band extender of claim 9 wherein:
a frequency used on the feeder cable to carry the upstream communications from the first local distribution network equals
a frequency used for upstream communication in the first local distribution network which equals
a frequency used on the feeder cable to carry the upstream communications from the second local distribution network which equals
a frequency used for upstream communication in the second local distribution network.

11. the multi-band extender of claim 6 wherein
the second port on the first directional tap is in data communication with a third filter set to pass an upstream frequency of the first local distribution network;
an upstream output of the third filter is in data communication with a combiner device;
an upstream output of the combiner device is in data communication with the first splitter device; and
The second port on the second directional tap is in data communication with a fourth filter set to pass an upstream frequency used by the second local distribution network;
an upstream output of the fourth filter is in data communication with an upstream frequency shifter that shifts the data communications on the upstream frequency used by the second local distribution network to a second upstream feeder cable frequency;
an output of the upstream frequency shifter is in data communication with a fifth filter set to pass the second upstream feeder cable frequency;
an upstream output of the fifth filter is in data communication with the combiner device; wherein:
A) upstream communications from the first local distribution network may travel upstream from the first local distribution network through the first directional tap exiting the second port before passing
through the third filter, before passing
through the combiner device, before passing
upstream through the first splitter device before reaching
the feeder cable;
B) upstream communications from the second local distribution network may travel upstream from the second local distribution network through the second directional tap exiting the second port before passing
through the fourth filter before passing
through the upstream frequency shifter before passing
through the fifth filter before passing
through the combiner device before reaching
the feeder cable; and
C) the feeder cable carries
television signals in the first frequency band;
downstream communications on the first frequency for use in the first local distribution network;
downstream communications on the second frequency (different from the first frequency) for use in the second local distribution network;
upstream communications from the first local distribution network; and
upstream communications from the second local distribution network on the second upstream feeder cable frequency.

12. The multi-band extender of claim 11 wherein the second upstream feeder cable frequency is above 1.0 GHz.

13. The multi-band extender of claim 11 wherein:
a frequency used on the feeder cable to carry the upstream communications from the first local distribution network equals
the frequency used for upstream communication of the first local distribution network which does not equal
the second upstream feeder cable frequency.

14. The multi-band extender of claim 11 wherein:
the upstream communications from the first local distribution network are shifted from the upstream frequency of the first local distribution network to a first upstream feeder cable frequency and the first upstream cable feeder frequency does not equal the second upstream feeder cable frequency.

15. The multi-band extender of claim 11 wherein:
a single heterodyne frequency source, provided by a synthesizer, is used by both the downstream frequency shifter and the upstream frequency shifter.

16. A network containing a multi-band extender for use in increasing the capacity of a feeder cable in a tree and branch distribution network; the network comprising:
A) a first local distribution network for the distribution of television signals in a first frequency band and data communications to and from at least one client modem; the downstream communications to the at least one client modem at a first local distribution network downstream frequency and the upstream communications from the at least one client modem at a first local distribution network upstream frequency;
B) an upstream end of the first local distribution network in data communication with a common port of a first diplexer;
C) a low frequency port of the first diplexer connected to an output of a television amplifier providing television signals in the first frequency band;
D) a high frequency port of the first diplexer connected to a first port of a first directional tap, the first directional tap with the first port passing a signal to a second port and to a third port, the second port isolated from the third port;
E) the third port of the first directional tap in data communication with a second splitter device, an upstream end of the second splitter device connected to an output of a first amplifier;
F) an input of the first amplifier connected to a first splitter device having an upstream port;
G) the upstream port of the first splitter device connected to a high frequency port on a second feeder cable diplexer,
H) the second feeder cable diplexer having a low frequency port and a common port; the low frequency port set to pass the television signals in the first frequency band to the television amplifier;
I) the common port of the second feeder cable diplexer in data communication with the feeder cable;
J) the second port of the first directional tap in data communication with a first filter set to pass the first local distribution network upstream frequency;
K) an upstream output of the first filter in data communication with a combiner device;
L) an upstream output of the combiner device in data communication with an upstream amplifier;
M) the upstream amplifier in data communication with the first splitter device;
N) a second local distribution network for the distribution of television signals in the first frequency band and data communications to and from at least one client modem; the downstream communications to the at least one client modem at a second local distribution network downstream frequency and the upstream communications from the at least one client modem at a second local distribution network upstream frequency;
O) an upstream end of the second local distribution network in data communication with a common port of a second diplexer;
P) a low frequency port of the second diplexer connected to the output of the television amplifier providing television signals in the first frequency band;
Q) a high frequency port of the second diplexer connected to a first port of a second directional tap, the second directional tap with the first port passing a signal to a second port and to a third port, the second port isolated from the third port;
R) the third port of the second directional tap in data communication with the second splitter device;
S) the second port of the second directional tap connected to a second filter set to pass the second local distribution network upstream frequency;
T) an upstream output of the second filter is in data communication with an upstream frequency shifter that shifts the data communications on the second local distribution network upstream frequency to a second upstream feeder cable frequency;
U) an output of the upstream frequency shifter is in data communication with a third filter set to pass the second upstream feeder cable frequency;
V) a upstream output of the third filter is in data communication with the combiner device;
whereby:
upstream communications from the first local distribution network may travel upstream from the first local distribution network through the first directional tap exiting the second port before passing
through the first filter before passing
through the combiner device, before passing
through the second feeder cable diplexer before reaching the feeder cable; and
upstream communications from the second local distribution network may travel upstream from the second local distribution network through the second directional tap exiting the second port before passing through
the second filter before passing through
the upstream frequency shifter before passing through
the third filter before passing through
the combiner device before passing through the second feeder cable diplexer before reaching the feeder cable; and
the feeder cable carries
television signals in the first frequency band;
downstream communications for use in the first local distribution network;
downstream communications for use in the second local distribution network; upstream communications from the first local distribution network; and
upstream communications from the second local distribution network on the second upstream feeder cable frequency.

17. The network of claim 16 wherein the second local distribution network upstream frequency is below 1.0 GHz and the second upstream feeder cable frequency is above 1.0 GHz.

18. A method of increasing the capacity of a tree and branch network feeder cable to carry television channels in a first frequency band and data communications to a first local distribution network and a second local distribution network, the first local distribution network and the second local distribution network carrying data communications in a second frequency band above the first frequency band and below an operational ceiling frequency for reliable service within the first and second local distribution networks; the method comprising:
isolating the first local distribution network from the second local distribution network such that downstream data communications on a first frequency in the first local distribution network cannot be received on the first frequency by a client modem in the second local distribution network;
sending downstream communications to the first local distribution network over the network feeder cable at a first downstream frequency;
sending downstream communications to the second local distribution network over the network feeder cable at a second downstream frequency, the second downstream frequency above the second frequency band and different from the first downstream frequency;
downstream of the network feeder cable, shifting the downstream communications on the second downstream frequency to a frequency in the second frequency band that matches a second local distribution network downstream frequency;
whereby the network feeder cable carries downstream:
television channels in the first frequency band;
downstream communications on the first downstream frequency; and
downstream communications on the second downstream frequency.

19. The method of claim 18 further comprising the step of:
downstream of the network feeder cable, shifting the downstream communications on the first downstream frequency to a frequency in the second frequency band that matches a first local distribution network downstream frequency.

20. The method of claim 18 further comprising the steps of:
sending upstream communications from the first local distribution network over the network feeder cable on a first upstream frequency;
downstream of the network feeder cable; shifting upstream communications from the second local distribution network from a second local distribution network upstream frequency in the second frequency band to a second upstream frequency above the second frequency band and different from the first upstream frequency; whereby the network feeder cable carries:
television channels in the first frequency band;
downstream communications on the first downstream frequency;
downstream communications on the second downstream frequency;
upstream communications on the first upstream frequency; and
upstream communications on the second upstream frequency.

21. A method of increasing the capacity of a tree and branch network feeder cable to carry television channels in a first frequency band and data communications to a first local distribution network and a second local distribution network, the first local distribution network and the second local distribution network carrying data communications in a second frequency band above the first frequency band and below an operational ceiling frequency for reliable service within the first and second local distribution networks; the method comprising:
isolating the first local distribution network from the second local distribution network such that downstream data communications on a first frequency in the first local distribution network cannot be received on the first frequency by a client modem in the second local distribution network;
sending downstream communications to the first local distribution network over the network feeder cable at a first downstream frequency;
sending downstream communications to the second local distribution network over the network feeder cable at a second downstream frequency, the second downstream frequency different from the first downstream frequency;
downstream of the network feeder cable, shifting the downstream communications on the second downstream frequency to a second local distribution network downstream frequency;
whereby the network feeder cable carries downstream:
television channels in the first frequency band;
downstream communications on the first downstream frequency; and
downstream communications on the second downstream frequency.

22. The method of claim 21 wherein the second downstream frequency is the range of 5 MHz to 42 MHz.

23. The method of claim 21 wherein the second downstream frequency is in the frequency range of 750 MHz to 860 MHz.

24. The method of claim 21 wherein the second downstream frequency is in the first frequency band.

25. The method of claim 21 wherein the second downstream frequency is in the second frequency band.
